(19) United States
(12) Patent Application Publication
(10) Pub. No.: US 2018/0336974 A1
(43) Pub. Date: Nov. 22, 2018

(54) PACKAGING DEVICE FOR RADIOACTIVE ISOTOPES PRODUCED IN FLEXIBLE ELONGATED SHAPES

(71) Applicant: Westinghouse Electric Company LLC, Cranberry Township, PA (US)

(72) Inventor: Michael D. Heibel, Harrison City, PA (US)

(73) Assignee: Westinghouse Electric Company LLC, Cranberry Township, PA (US)

(21) Appl. No.: 15/596,002

(22) Filed: May 16, 2017

(51) Int. Cl. G21F 5/06; G21F 5/015

(52) U.S. Cl. CPC G21F 5/065; G21F 5/015

(57) ABSTRACT

A methodology and device that is capable of packaging highly radioactive materials configured in long elongated linear shapes into tight coils that can easily be placed into the small payload storage areas of typical commercially available radioactive material shipping containers. The design of the device allows the reconfiguration of the radioactive material to manually occur in a manner that allows the operator of the device to remain shielded from the radiation to prevent over-exposure of the operator to the nuclear radiation being emitted from the radioactive material.

### BACKGROUND

### 1. Field

This invention relates generally to the compaction and shielding of radioactive material for storage or shipment and more particularly to the compaction of irradiated isotopes and shielding for shipment to a processing facility.

### 2. Related Art

A number of operating nuclear reactors employ a moveable in-core detector system such as the one described in U.S. Pat. No. 3,932,211. The moveable detector system generally comprises four, five or six detector/drive assemblies, depending upon the size of the plant (two, three or four loops), which are interconnected in such a fashion that they can assess various combinations of in-core flux thimbles. To obtain the thimble interconnection capability, each detector has associated with it a five-path and ten-path rotary mechanical transfer device. A core map is made by selecting, by way of the transfer devices, particular thimbles through which the detectors are driven. To minimize mapping time, each detector is capable of being run at high speed (72 feet per minute) from its withdrawn position to a point just below the core. At this point, the detector speed is reduced to 12 feet per minute and the detector traversed to the top of the core, direction reversed, and the detector traversed to the bottom of the core. The detector speed is then increased to 72 feet per minute and the detector is moved to its withdrawn position. A new flux thimble is selected for mapping by rotating the transfer devices and the above procedure repeated.

FIG. 1 shows the basic system for the insertion of the movable miniature detectors. Retractable thimbles 10, into which the miniature detectors 12 are driven, take the routes approximately as shown. The thimbles are inserted into the reactor core 14 through conduits extending from the bottom of the reactor vessel 16 through the concrete shield area 18 and then up to a thimble seal table 20. Since the movable detector thimbles are closed at the leading (reactor) end, they are dry inside. The thimbles, thus, serve as a pressure barrier between the reactor water pressure (2500 psig design) and the atmosphere. Mechanical seals between the retractable thimbles and the conduits are provided at the seal table 20. The conduits 22 are essentially extensions of the reactor vessel 16, with the thimbles allowing the insertion of the in-core instrumentation movable miniature detectors. During operation, the thimbles 10 are stationary and will be retracted only under depressurized conditions during refueling or maintenance operations.

Withdrawal of a thimble to the bottom of the reactor vessel is also possible if work is required on the vessel internals.

The drive system for insertion of the miniature detectors includes basically drive units 24, limit switch assemblies 26, five-path rotary transfer devices 28, 10-path rotary transfer devices 30, and isolation valves 32, as shown. Each drive unit pushes a hollow helical-wrap drive cable into the core with a miniature detector attached to the leading end of the cable and a small diameter coaxial cable, which communicates the detector output, threaded through the hollow center back to the trailing end of the drive cable.

The use of the Movable In-core Detector System flux thimbles 10 for the production of irradiation desired neutron activation and transmutation products, such as isotopes used in medical procedures, requires a means to insert and withdraw the material to be irradiated from inside the flux thimbles located in the reactor core 14. Preferably, the means used minimizes the potential for radiation exposure to personnel during the production process and also minimizes the amount of radioactive waste generated during this process. In order to precisely monitor the neutron exposure received by the target material to ensure the amount of activation or transmutation product being produced is adequate, it is necessary for the device to allow an indication of neutron flux in the vicinity of the target material to be continuously measured. Ideally the means used would be compatible with systems currently used to insert and withdraw sensors within the core of commercial nuclear reactors. This invention describes an Isotope Production Cable Assembly that satisfies all the important considerations described above.

Copending U.S. patent application Ser. No. 15/210,231, entitled: Irradiation Target Handling Device, filed Jul. 14, 2016, describes an Isotope Production Cable Assembly that satisfies all the important considerations described above for the production of medical isotopes that need core exposure for less than a full fuel cycle. The Isotope Production Cable Assembly shown in FIGS. 2-5 is composed of two main elements, i.e., a Driver Cable Assembly 36 and a Target Holder Element 38. The major component is the Drive Cable Assembly 36. The Drive Cable Assembly 36 comprises a cable constructed to be compatible with the drive mechanism requirements for the existing cable drive systems used to insert and withdraw sensors 12 within commercial nuclear reactor cores 14, such as the Westinghouse Movable In-core Detector System that is schematically shown in FIG. 1. The Drive Cable Assembly 36 interior contains the signal lead 42 for a self-powered detector element 45. The active portion of the self-powered detector 45 is a spiral wound around the exterior of the inserted end of the drive cable 40 with a length sufficient to provide a robust signal output and a minimum of axial position difference from end to end. The output from the self-powered detector 45 is used to identify the reactor flux at the self-powered detector position in the reactor core 14 to allow the axial position of the target material to be optimized.

The Drive Cable Assembly 36, which is a replacement for an existing drive cable to which one of the miniature detectors 12 was coupled to, attaches to a Target Holder Element Cable Assembly 38 using the ball clasp arrangement (also known as a ball chain coupling) identified in FIGS. 2-5 by reference characters 48 and 50. The ball and clasp arrangement has a ball or male portion 48, shown in FIGS. 2, 4 and 5, connected to the reactor insertion end of the Drive Cable Assembly 36. FIG. 2 shows a plan view of the ball portion 48, FIG. 4 shows a frontal view and. FIG. 5 shows a side view. The clasp portion 50 is attached to a target material holder element 38 on the Target Holder Element Cable Assembly 38 with connector pins 52. The ball portion 48 of the quick disconnect coupling is designed to fit within and be detachably captured by the clasp portion 50. The Target Holder Element Cable Assembly 38 comprises the target material holder 43, which is a hollow cylinder of a very thin metal mesh that has a length sufficient to hold the desired amount of target material within the confines of the active reactor core 14. After the target material is withdrawn from the reactor, the Target Holder Element Cable Assembly 38 may be easily and quickly disconnected from the Drive Cable Assembly 36 so the entire Target Holder Element Cable Assembly may be shipped to a processing facility. The cap 44 indicated on the inserted end of the Target Holder Element Cable Assembly 38 is held in place by a ring clamp 46. The ring clamp 46 is designed to be simple to remove at the processing facility. Once it is removed the irradiated material may be removed from the inside of the Target Holder Element Cable Assembly. Only the Target Holder Element Cable Assembly 38 is disposed of following irradiation. The Drive Cable Assembly 36 is reused as long as mechanically practical.

The Target Holder Element 38 has to be configured to allow it to fit inside the Payload Compartment of a MIDUS B style of radioactive material transport cask. The Target Holder Element Cable Assembly described above will need to be at least 4.5 feet in length to contain the target amount of Mo-99 at the end of a 7 EFPD (Effective Full Power Days) irradiation. The Payload Compartment of the MIDUS B Shipping Cask to be used to transport the irradiated target to the processing facility is a volume three inches in diameter and six inches tall. The activity of the target when it is removed from the core for shipping will be at least 3402 Ci (Curie). The dose rate this provides at 12 inches in air is approximately 5055 R/hour (Roentgen per hour). Exposure to this amount of gamma radiation would lead to a fatal dose to humans in minutes. This amount of radiation also limits the lifetime of electrical components making the automation of the process needed to reconfigure the target into a form that can be placed inside the Payload Compartment a high maintenance activity. The device described herein provides a process and device that can be used to manually reconfigure the targets described above, or any similar device, into a tight coil that can be easily placed into the Payload Compartment of a MIDUS B transportation cask, or casks of similar design. The configuration and operation methodology of the device of this invention also allows the target to be easily shielded to allow either manual or remote controlled operation.

### SUMMARY

This invention teaches apparatus for compacting a radioactive, elongated, linear member into a coil and loading the coil into a shielded cask. The apparatus includes an intake guide structured to receive the radioactive, elongated, linear member and direct the radioactive, elongated, linear member into a shielded cavity. A Threaded Advancing Mechanism Spindle is rotatably supported within the shield cavity and supports the intake guide in a fixed orientation and advances the intake guide in the fixed orientation along the Threaded Advancing Mechanism Spindle as the Threaded Advancing Mechanism Spindle is rotated. A Rabbit Coil Spindle is also rotatably supported within the shielded cavity at a greater depth within the shielded cavity than the Threaded Advancing Mechanism Spindle. The Rabbit Coil Spindle has a Rabbit Nose Grabber proximate a first end that is structured to receive and anchor a lead end of the radioactive, elongated, linear member and a Rabbit Tail Grabber proximate a second end, structured to receive and anchor a tail end of the radioactive, elongated, linear member. The intake guide is aligned to direct the radioactive, elongated linear member to the Rabbit Coil Spindle, with both the Threaded Advancing Mechanism Spindle and the Rabbit Coil Spindle being supported from a first and second opposing walls of the shielded cavity. A drive system is connected through the first wall of the shielded cavity and is operable to rotate the Threaded Advancing Mechanism Spindle and the Rabbit Coil Spindle. At least a portion of the second wall of the shielded cavity, rotatably supporting the Rabbit Coil Spindle, is operable to open and expose one end of the Rabbit Coil Spindle.

The invention further contemplates means for decoupling the Rabbit Coil Spindle from the drive system when the portion of the second wall of the shielded cavity is open and moving the decoupled Rabbit Coil Spindle through the opening and out of the shielded cavity. In one embodiment, the apparatus includes means for facilitating rotation of the shielded cavity from a horizontal position to a vertical position with the second wall facing in a downward direction at the bottom of the shielded cavity. Preferably, the drive system drives both the Threaded Advancing Mechanism Spindle and the Rabbit Coil Spindle off of the same drive gear, and, in one embodiment both spindles are driven at the same speed.

In another embodiment, the means for decoupling the Rabbit Coil Spindle from the drive system when the portion of the second wall of shielded cavity is open, moves the decoupled Rabbit Coil Spindle through the opening, out of the shielded cavity and into a shielded transportation or storage cask. Such apparatus may further include a centering device for centering the decoupled Rabbit Coil Spindle as it is moved into the shielded transportation or storage cask.

### BRIEF DESCRIPTION OF THE DRAWINGS

A further understanding of the invention can be gained from the following description of the preferred embodiments when read in conjunction with the accompanying drawings in which:

FIG. 1 is a perspective view of a prior art in-core moveable detector arrangement that can be employed with this invention;

FIG. 2 is a schematic representation of one embodiment of an Isotope Production Cable Assembly Drive Cable Assembly of co-pending U.S. patent application Ser. No. 15/210,231;

FIG. 3 is a plan view of the Target Holder Element and the female portion of the quick disconnect that connects the Target Holder Element Cable Assembly to the Drive Cable Assembly shown in FIG. 2;

FIG. 4 is a frontal view of the male portion of the quick disconnect shown on the core insertion side of the Drive Cable Assembly shown in FIG. 2;

FIG. 5 is a side view of the male portion of the quick disconnect shown in FIGS. 2 and 4;

FIG. 6 is a perspective view of one embodiment of the apparatus of this invention;

FIG. 7 is a side cutaway view of the apparatus of FIG. 6;

FIG. 8 is a bottom view of the apparatus of FIG. 7 rotated 90°;

FIG. 9 is a schematic bottom view showing the apparatus being rotated 90°;

FIG. 10 is a side cutaway view showing the target coil wound on the Rabbit Coil Spindle being loaded into a transfer cask; and

FIG. 11 is a cutaway perspective view of the rabbit being wound around the Rabbit Coil Spindle inside the shielded cavity.

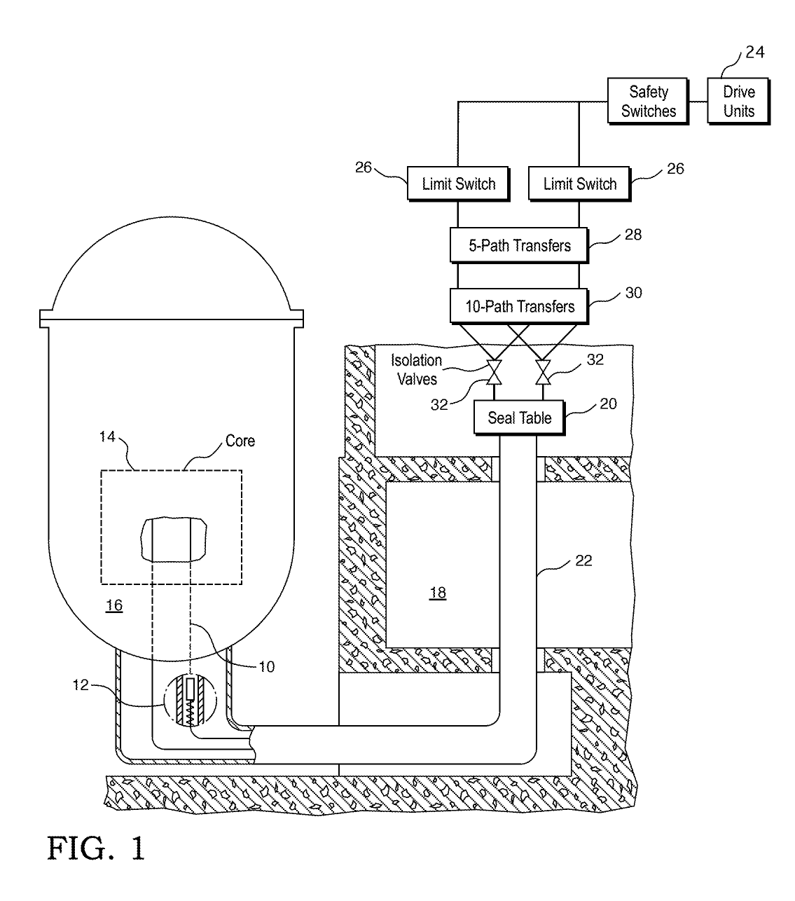

### DESCRIPTION OF THE PREFERRED EMBODIMENT

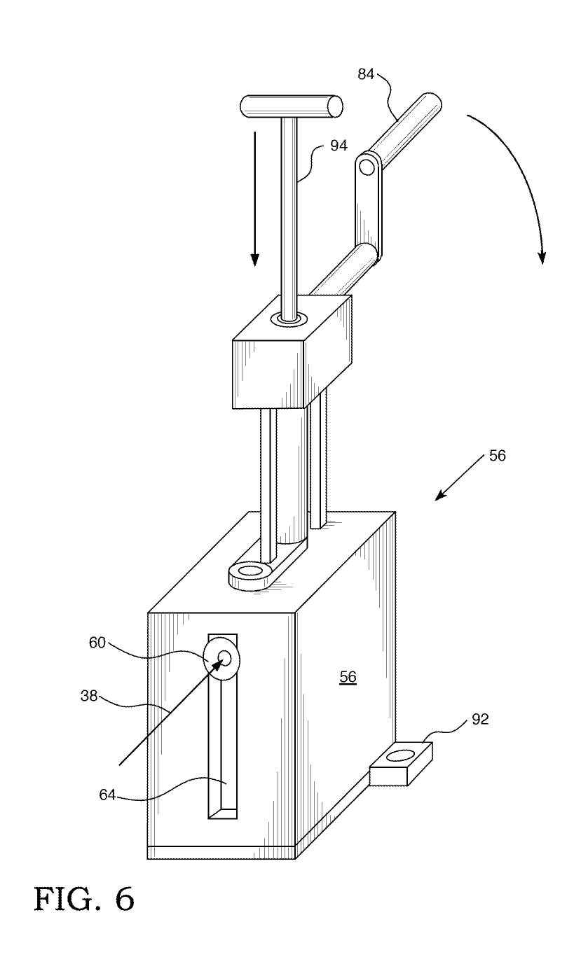

One preferred embodiment of the apparatus 54 of this invention is shown in FIGS. 6-11 and, preferably, is constructed using Tungsten for the shielded cavity 56 surrounding the interior components. The exterior and other components are constructed using less expensive metals such as SS-316L, or even Aluminum. The target to be fed into the Apparatus 54 can be any isotope or isotope contained within a holder that is produced in a flexible elongated shape. In this embodiment the target is the target holder element 38 and is fed into the shielded cavity 56 through an intake guide 60. It should be appreciated that sometimes the target is referred to herein as an isotope or an isotope housed within a holder and at other times as a rabbit, but in each case it is intended to be referring to the feed to be operated upon by the apparatus of this invention. In this embodiment the intake guide 60 is a rabbit guide funnel that is supported within the shield cavity 56 in a fixed orientation on a Threaded Advancing Mechanism Spindle 62 that is rotatably supported within the shield cavity 56. The intake guide 60 moves across the intake opening 64 as the Threaded Advancing Mechanism Spindle 62 is rotated. A Rabbit Coil Spindle 66 is rotatably supported within the shielded cavity 56 at a greater depth within the shielded cavity than the Threaded Advancing Mechanism Spindle 62. The Rabbit Coil Spindle 66 has a Rabbit Nose Grabber 68 proximate a first end that is structured to receive and anchor a lead end of the rabbit and a Rabbit Tail Grabber 70 proximate a second end that is structured to receive and anchor a tail end of the rabbit 38. The intake guide 60 is aligned to direct the rabbit to the Rabbit Coil Spindle 66, with both the Threaded Advancing Mechanism Spindle 62 and the Rabbit Coil Spindle 66 being supported from a first and second opposing walls, respectively 72 and 74, of the shielded cavity 56. A drive system 76 is connected through the first wall 72 of the shielded cavity 56 and is operable to rotate the Threaded Advancing Mechanism Spindle 62 and the Rabbit Coil Spindle 66. At least a portion 78 of the second wall 74 of the shielded cavity 56, rotatably supporting the Rabbit Coil Spindle 66, is operable to open and expose one end of the Rabbit Coil Spindle. Both the Threaded Advancing Mechanism Spindle 62 and the Rabbit Coil Spindle 66 are supported from the first and second walls 72 and 74 by rotational bearings 80, but the Rabbit Coil Spindle is slidably connected to the bearings 80 with spindle linkage tabs 82, so that the Rabbit Coil Spindle 66 is readily disconnected from the bearings 80 when the portion 78 of the second wall 74 is opened.

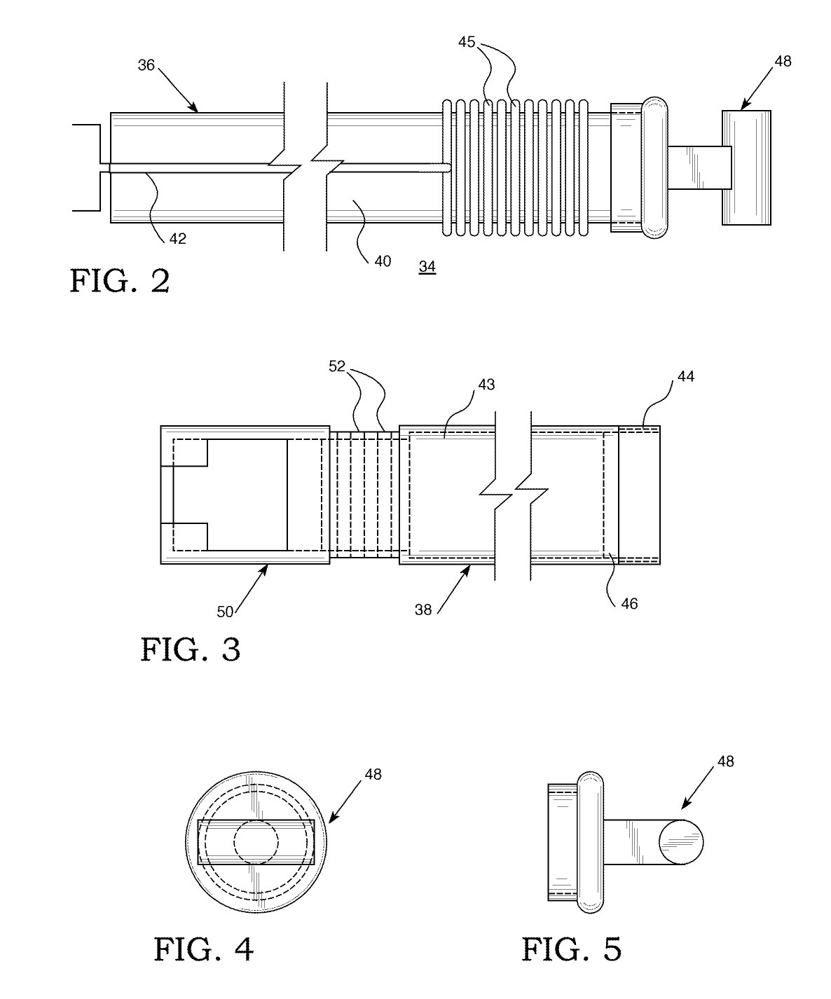

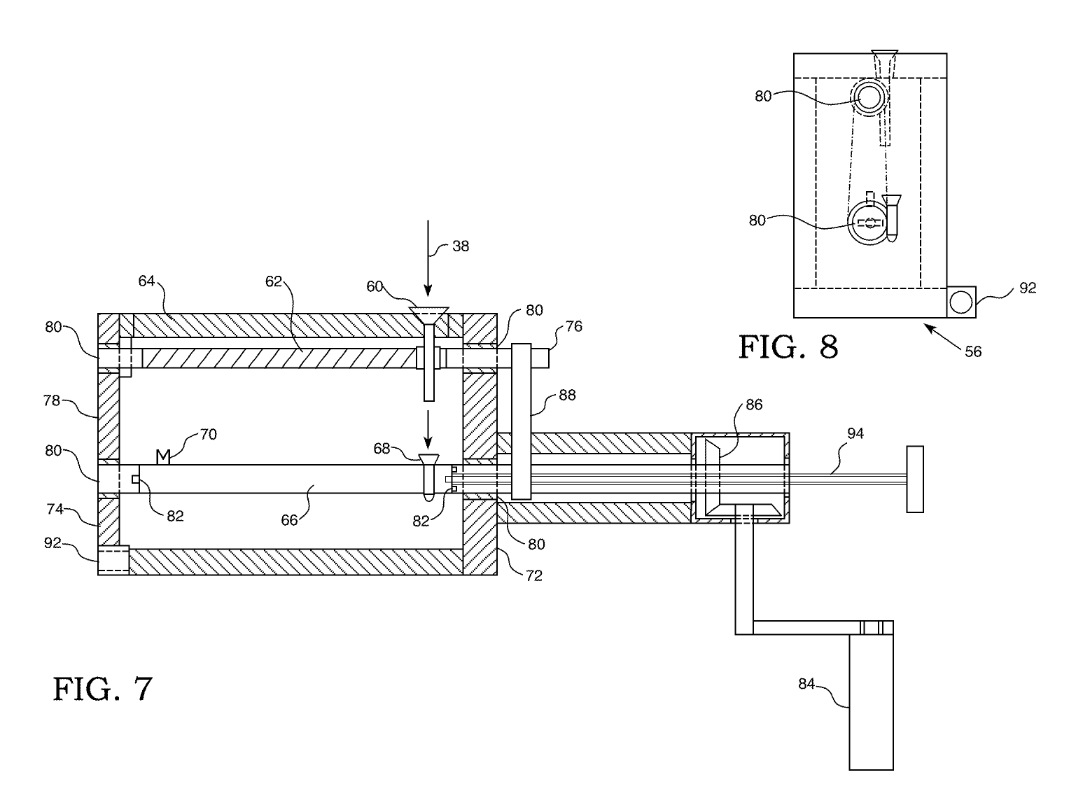

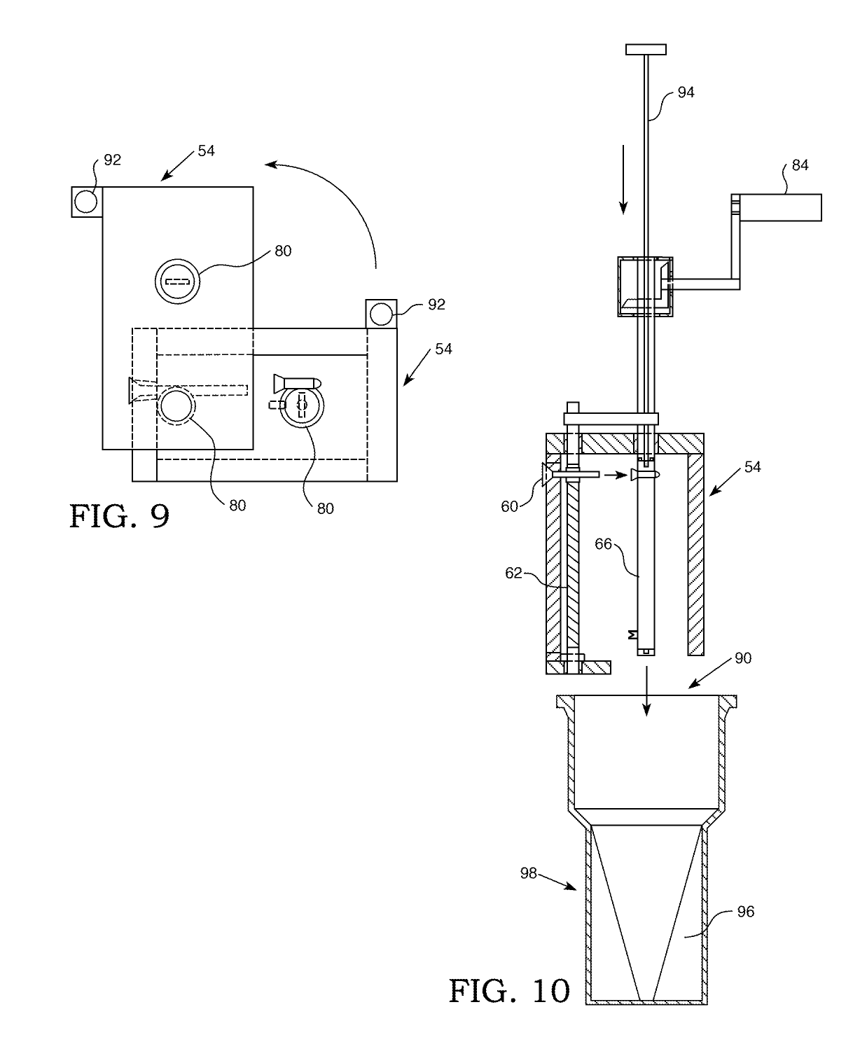

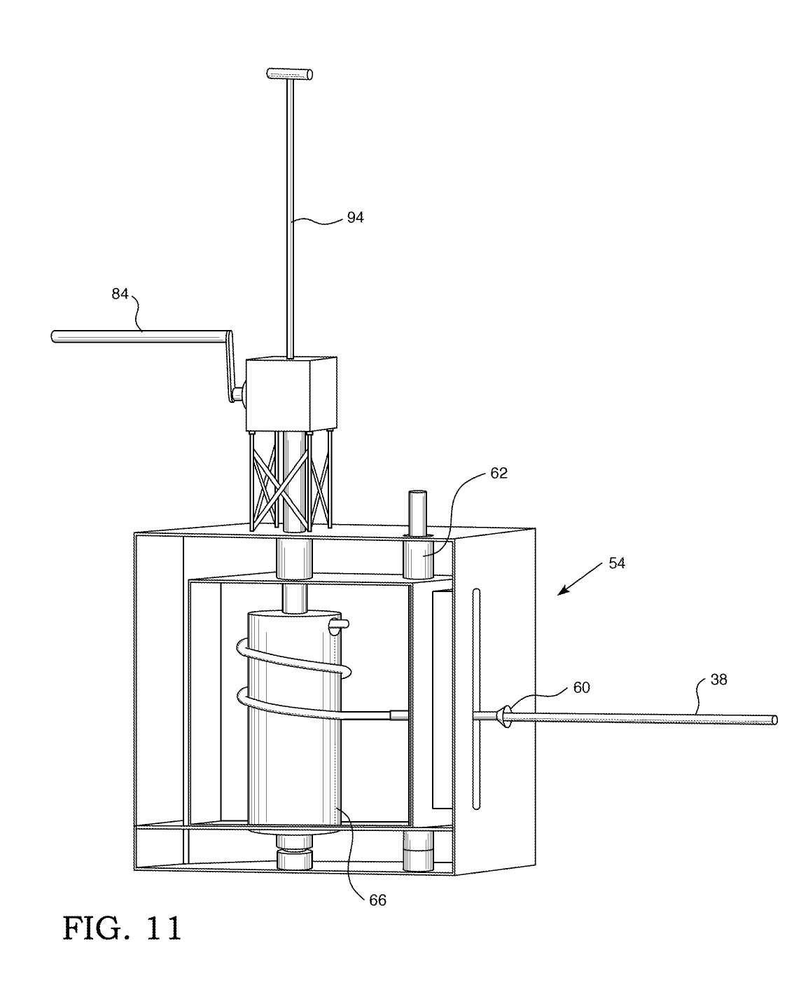

The operation of the device 54 begins with the insertion of the target 38 into the target funnel 60 until it is lodged in the Rabbit Nose Grabber 68 shown in FIG. 7. This can be accomplished remotely by advancing the drive cable 36. The nose grabber 68 may also be embodied as a penetration directly through the Rabbit Coil Spindle 66. The insertion of the target 38 continues when the rotational handle 84 is turned to cause both the Rabbit Coil Spindle 66 and Threaded Advancing Mechanism Spindle 62 to turn by way of the bevel gears 86 and the gear chain 88. As the Threaded Advancing Mechanism Spindle 62 rotates, the rabbit guide funnel 60 moves relative to the Rabbit Coil Spindle 66 to progressively wrap the target 38 down the length of the Rabbit Coil Spindle 66. The thread spacing on the Threaded Advancing Mechanism Spindle 62 is spaced such that a position near the end of the target 38 is captured by the Rabbit Tail Grabber 70 shown in FIG. 7. The target 38 is then disconnected from the drive cable 36 shown in FIG. 2 and the rest of the target 38 is wound into the device 54. Once the device 54 is rotated 90°, as shown in FIG. 9, and properly positioned over the center of a Transfer Cask Payload Cavity 90 as shown on FIG. 10, the bottom panel, i.e., the swing out portion 78 of the second wall 74, is rotated to the open position using remote tooling to pull the bottom panel at the Bottom Rotation Assistance Lug 92 shown in FIGS. 7, 8 and 9. Once the device is opened, the Rabbit Payload Positioning Handle 94 is inserted until the target 38 is firmly embedded in the payload cavity centering device 96. Once the tarnet 38 is firmly inserted, the Rabbit Payload Positioning Handle 94 is rotated to unscrew the handle from the Rabbit Coil Spindle 66. The Rabbit Payload Positioning Handle 94 is then withdrawn until it is high enough to allow the swing out panel 78 of the device 54 to be rotated back into the closed position. FIGS. 7, 8, 9 and 10 illustrate the process. FIG. 11 shows a view of the target 38 being wound around the Rabbit Coil Spindle 66.

The design of the foregoing preferred embodiment includes the flexibility to adjust the distance of the devices used to manipulate the Rabbit Coil Spindle 66 and the coil to account for the radiation dose rate goals for the operators of the device. The device is configured to allow the inclusion of additional shielding between the rabbit coil and the manipulation controls of the device as needed to meet target exposure goals for the equipment operators. Because the distance and shielding flexibility provided by the design allow the radiation exposure to the manipulation control areas to be minimized, it is also practical to use off-the-shelf electronics and electro-mechanical devices to automate the manipulation process so that the necessary manipulations can be performed remotely. Accordingly, this device allows the manipulation of extremely high levels of radioactive materials using either manual of automated processes. It allows large amounts of valuable radioisotopes to be packaged for shipping while minimizing the potential for dangerous radiation exposure. This device can also be used to package the cables and fission chambers used by the Movable In-core Detector System (MIDS) used in vintage Westinghouse-style plants, and the Traversing In-core Probe System (TIPS) in all BWR plants for disposal.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. Apparatus for compacting a radioactive, elongated, linear member into a coil and loading the coil into a shielded cask comprising:
an intake guide structured to receive the radioactive, elongated, linear member and direct the radioactive, elongated, linear member into a shielded cavity;
a Threaded Advancing Mechanism Spindle rotatably supported within the shield cavity and supporting the intake guide in a fixed orientation and advancing the intake guide in the fixed orientation along the Threaded Advancing Mechanism Spindle as the Threaded Advancing Mechanism Spindle is rotated;
a Rabbit Coil Spindle rotatably supported within the shielded cavity at a greater depth within the shielded cavity than the Threaded Advancing Mechanism Spindle, the Rabbit Coil Spindle having a Rabbit Nose Grabber proximate a first end that is structured to receive and anchor a lead end of the radioactive, elongated, linear member and a Rabbit Tail Grabber proximate a second end, structured to receive and anchor a tail end of the radioactive, elongated, linear member, the intake guide aligned to direct the radioactive, elongated linear member to the Rabbit Coil Spindle, with both the Threaded Advancing Mechanism Spindle and the Rabbit Coil Spindle being supported from a first and second opposing wall of the shielded cavity;
a drive system connected through the first wall of the shielded cavity operable to rotate the Threaded Advancing Mechanism Spindle and the Rabbit Coil Spindle; and
at least a portion of the second wall of the shielded cavity rotatably supporting the Rabbit Coil Spindle operable to open and expose one end of the Rabbit Coil Spindle.

2. The apparatus of claim 1 including means for decoupling the Rabbit Coil Spindle from the drive system when the at least the portion of the second wall of the shielded cavity is open, and moving the decoupled Rabbit Coil Spindle through the opening and out of the shielded cavity.

3. The apparatus of claim 2 wherein the Rabbit Coil Spindle is supported from the first and second walls through rotation bearings and the means for decoupling the Rabbit Coil Spindle from the drive system comprises spindle linkage tabs connecting the Rabbit Coil Spindle to the rotation bearings on the first and second walls.

4. The apparatus of claim 2 wherein the means for decoupling the Rabbit Coil Spindle from the drive system when the at least the portion of the second wall of shielded cavity is open moves the decoupled Rabbit Coil Spindle through the opening, out of the shielded cavity and into a shielded transportation or storage cask.

5. The apparatus of claim 4 including a centering device for centering the decoupled Rabbit Coil Spindle as it is moved into the shielded transportation or storage cask.

6. The apparatus of claim 1 including means for facilitating rotation of the shielded cavity from a horizontal position to a vertical position with the second wall facing in a downward direction at the bottom of the shielded cavity.

7. The apparatus of claim 1 wherein the drive system drives both the Threaded Advancing Mechanism Spindle and the Rabbit Coil Spindle off of the same drive gear.

8. The apparatus of claim 1 wherein the drive system drives both the Threaded Advancing Mechanism Spindle and the Rabbit Coil Spindle at the same speed.
